(19) United States
(12) Patent Application Publication
(10) Pub. No.: US 2026/0229549 A1
(43) Pub. Date: Aug. 6, 2026

(54) ADVANCED ANISOTROPIC 3D CURRENT COLLECTOR WITH TAILORED ELECTRON TORTUOSITY OPTIMIZED TOWARDS THE DIRECTION OF TABS

(71) Applicant: THEION GMBH, Berlin (DE)

(72) Inventors: Pushpendra KUMAR, Berlin (DE); Marek SLAVIK, Berlin (DE); Andréa Joris Quentin MARTIN, Berlin (DE); Thomas PEHL, Berlin (DE); Marin PUGET, Berlin (DE)

(73) Assignee: THEION GMBH, Berlin (DE)

(21) Appl. No.: 19/155,115

(22) PCT Filed: Feb. 24, 2023
(86) PCT No.: PCT/EP2023/054737

§ 371 Date: Aug. 8, 2025

(51) Int. Cl. H01M 4/80; H01M 10/0525

(52) U.S. Cl. CPC H01M 4/80; H01M 10/0525

(57) ABSTRACT

Embodiments are disclosed related to a current collector comprising a porous, freestanding, three-dimensional structure and at least one current collector tab. The current collector tab and the three-dimensional structure are connected. The three-dimensional structure comprises at least one layer that is formed of a one-dimensional (1D) nanomaterial, a two-dimensional (2D) nanomaterial, or mixtures thereof, and wherein the nanomaterial in the layer is aligned towards the current collector tab.

### TECHNICAL FIELD

The present invention relates to an advanced three-dimensional (3D) current collector comprising a low tortuous artificial electron percolation network present within the 3D body that exhibits non-homogeneous electric conductivity towards the direction and or placement of current collector tabs, a method for making such a current collector, and devices comprising the same. More particularly, it relates to a current collector comprising a porous, freestanding, 3D structure comprising one or more layer(s) of nanomaterial(s) aligned towards at least one current collector tab that is connected to said 3D structure.

### BACKGROUND OF THE INVENTION

This past decade has seen extensive research in storage devices for electrical energy such as lithium-based batteries due to their critical role in the energy transition and many applications like mobile phones, laptop computers, or electric vehicles. In particular, there is an ever-growing demand for storage devices with improved power performance, higher energy density, longer lifespan, and safety. Such storage devices generally include positive and negative electrodes, a separator, and redox-active materials.

Current collectors are typically made of copper, nickel, or aluminum with isotropic electric conductivity and are attached to electrodes to extract current from the storage device. Current collector foil also provides mechanical support to the electrode as It moves through the subsequent cell production processes in cutting-edge slurry-based electrodes defining current collector foil as a process substrate. For a number of applications, however, there may still be potential for improvement, in particular of the electrical properties such as electrical conductivity as well as of the physicochemical and thermal properties.

State-of-the-art alkali-ion batteries use transition metal (TM)-based cathodes, typically exhibiting ~5% volumetric fluctuation on cycling, which means, with an average of about 30% cathode porosity, NCA, LCO, or other insertion or intercalation active masses could safely accommodate volumetric fluctuation internally within the voids of electrodes. However, next-generation cathode and anode active materials including sulfur, lithium metal, silicon, germanium, tin, etc., with typical 30% porosity cannot provide enough volume to accommodate cyclical structural volumetric changes in such batteries over time. For example, sulfur theoretically expands about 79% on full lithiation and 157% on sodiation, whereas lithium metal expands or shrinks at 100% on plating or stripping. Furthermore, after the first Li stripping/discharging, lithium metal foil never achieves the similar surface morphology as it possesses in its pristine state, leaving about 30% as irreversible defragmentation losses, which progressively increase on further cycling. Typical slurry-based batteries, follow the particle-aggregate-cluster (PAC) principles to form electron percolation networks or paths, in order to transport electrons within electrodes, a myriad of individual particles must participate.

In the case of sulfur, the volumetric fluctuation during cycling is ~79%, and state-of-the-art (SOA) cathode porosity is ~45%. Thus, it is clear that available space is not capable of fully compensating the volume fluctuation, which also affects the electrolyte soaked into or infiltrated into the cathode voids. In general, this process is called “cathode breathing,” where cathode voids continually shrink and expand, and the electrolyte that occupies those voids is expelled and swept in and out during cycling. For the “post-lithium” batteries, the active materials must have a built-in mechanism to deal with the “breathing aspect” of electrodes. Another crucial factor that has an impact is the current distribution non-uniformity (CDNU) factor, which is amplified by the cyclic structural re-arrangement of the cathode based on PAC principles. Electron (e−) paths present within the SOA electrodes must have a sufficient degree of flexibility to allow prolonged cycling and for the large area electrode with minimum degradation Electrode sizes, areal active mass loadings, type of current collector foils, tab size, placement of the tabs, etc. influence CDNU and, in most cases, are the critical factor for cell failure during scaling, whereas good results are obtained from coin-sized to electrodes exceeding area over 120 cm² , which is typical for commercial batteries.

An object of the present invention is therefore to provide a current collector capable of selectively distributing electrons within an artificially made electron percolation network that is present within the current collector. The primary effect of such a current collector is to enhance and equalize CDNU within electrodes resulting in an improved electronic transport due to the shortest path of travel (low tortuosity), reduced internal resistance, and in the non-homogeneous distribution of redox reactions across the electrodes.

Due to their exceptional properties, a wide range of applications has been suggested for nanomaterials, including zero-dimensional (0-D) materials such as quantum dots and nanoparticles, one-dimensional (1D) materials such as nanotubes, nanorods, nanofibers and nanowires, and two-dimensional (2D) materials such as nanoplates and nanoflakes. If a material does not have any dimensions that are small enough to be considered nano-sized, then it is not a nanomaterial. It is known that these nanomaterials can be used to prepare macroscale objects such as freestanding, self-supported three-dimensional (3D) networks. For example, carbon nanotubes (CNTs) can be formed into a 3D network or sheet/paper-like structure, commonly referred to as ‘Buckypaper’ which consists of entangled assemblies of randomly distributed CNTs. Buckypapers are, in general, fabricated by vacuum filtration of CNT and/or graphene dispersion and/or by sequentially lifting CNT/graphene layers through a filter membrane. Electrodes based on self-supported bucky papers have gained significant attention recently and were found to illustrate superior performance.

Methods to align CNTs have also been reported, including (i) mechanical stretching of cross-linked CNT mats as described in U.S. Pat. No. 8,246,886 B2, (ii) pushing or “domino pushing” or pulling of vertically aligned carbon nanotubes (VACNTs) as described by Wang et al. (Nanotechnology, 2008; 19(7), 75609; DOI: 10.1088/0957-4484/19/7/075609), (iii) the application of large magnetic fields as disclosed in US Patent Application No. 2002/0185770 and U.S. Pat. No. 7,803,262 B2, and (iv) the application of an electric field as, for example, reported by Zhu et al. (J. Appl. Phys. 105, 054319(2009 ); https://doi.org/10.1063/1.3080243) and Zhang et al. (J. Nanosci. Nanotechnol. 9, 2887-2893, 2009; doi:10.1166/jnn.2009.014).

Accordingly, the present invention aims to provide a current collector with excellent physicochemical, thermal, and electrical properties for a variety of applications that can be environmentally friendly produced without compromising the physical state and chemical properties of 1D/2D nanomaterials. Further objectives will become apparent on the basis of the following description and the patent claims.

### SUMMARY OF THE INVENTION

In one aspect, the invention relates to current collectors comprising a porous, freestanding, three-dimensional structure; and at least one current collector tab, the at least one tab and the three-dimensional structure being connected, wherein the three-dimensional structure comprises at least one layer that is formed of a one-dimensional (1D) nanomaterial, a two-dimensional (2D) nanomaterial, or mixtures thereof, and wherein the nanomaterial in said layer is aligned towards the at least one tab.

The 1D and 2D nanomaterial may, for example, be made of pure carbonaceous materials such as CNTs or graphene; doped carbonaceous materials such as nitrogen-, oxygen or fluorine-doped carbon; non-carbonaceous materials such as metals or metal oxides; or mixtures of any of the foregoing. The 1D nanomaterial may, for example, be a nanotube, nanorod, nanofiber or nanowire made up of any of the materials mentioned above, including, for example, a carbon nanotube or boron-carbon-nitride nanotube. The 2D nanomaterial may, for example, be a nanosheet, nanoplate or nanoflake made up of the precedingly indicated materials, including, for example, materials such as graphene, graphene oxide, reduced graphene oxide, Mxenes, graphitic carbon nitride, hexagonal boron nitride, silicene, phosphorene, germanene, hexagonal boron nitride nanosheet, or a transition metal dichalcogenide nanosheet.

In a further aspect, the invention relates to devices comprising the current collector such as an electrode, a primary or secondary energy storage device, or an electrochemical cell. The device may, for example, be a battery comprising alkali/alkali earth metal/ion (e.g., Li, Na, K, Ca, Mg, Al, Zn, etc.) such as a lithium-ion, sodium-ion, aluminum-ion, zinc-ion, potassium-ion, calcium-ion, magnesium-ion battery; or alkali/alkali earth metal chalcogenide such as a lithium-sulfur, lithium-selenium, lithium-sulfur-selenium, sodium-sulfur, sodium-selenium, aluminum-sulfur, potassium-sulfur, calcium-sulfur, magnesium-sulfur battery; or alkali/alkali earth metal air such as a lithium-air, sodium-air, aluminum-air, zinc-air battery, In another aspect, the invention relates to methods of preparing the current collector, such as methods based on the dielectrophoretic alignment of nanomaterials, layer-by-layer (LbL) assembly of layers of the aligned nanomaterials and connection of the assembled layers to the current collector tab by welding, stamping, or crimping.

For clarity, some definitions of terms are given which are used throughout the description and claims. The definitions should be used to determine the meaning of the respective expressions unless the context requires a different meaning.

The terms ‘a’ or ‘an’ do not exclude a plurality, i.e., the singular forms ‘a’, ‘an’ and ‘the’ should be understood as to include plural referents unless the context clearly indicates or requires otherwise. In other words, all references to singular characteristics or limitations of the present disclosure shall include the corresponding plural characteristic or limitation, and vice versa, unless explicitly specified otherwise or clearly implied to the contrary by the context in which the reference is made The terms ‘a’, ‘an’ and ‘the’ hence have the same meaning as ‘at least one’ or as ‘one or more’ unless defined otherwise. For example, reference to ‘a nanomaterial’ includes mixtures of nanomaterials, and the like.

The terms ‘comprise’, ‘comprises’, and ‘comprising’ and similar expressions are to be construed in an open and inclusive sense, as ‘including, but not limited to’.

The terms ‘essentially’, ‘about’, ‘approximately’, ‘substantially’, and the like in connection with an attribute or value include the exact attribute or the precise value, as well as any attribute or value typically considered to fall within a normal range or variability accepted in the technical field concerned.

The terms ‘binder free’ and ‘surfactant-free mean that no binder or surfactant is deliberately included in a material but does not exclude the presence of residual quantities. That is to say, the term “free” means that a material contains less than a functional amount of the respective constituent, typically less than 1% by weight, preferably less than 0.1% or even less than 0.01%, and including zero percent by weight of the respective constituent.

### BRIEF DESCRIPTION OF THE DRAWINGS

FIG. 1 is a schematic drawing of a layer of a porous, freestanding, three-dimensional structure with aligned 1D nanomaterial towards one current collector tab.

FIG. 2 is a schematic drawing of a layer of a porous, freestanding, three-dimensional structure with aligned 1D nanomaterial towards two current collector tabs FIG. 3 is a schematic drawing of a layer of a porous, freestanding, three-dimensional structure with aligned 1D nanomaterial towards three current collector tabs.

FIG. 4A is a photograph showing an example of generating a layer of aligned 1D nanomaterial with desired distances between the aligned nanomaterial (502) in a process (500) for the production of a current collector. FIG. 4B is a photograph of a section of a layer of aligned 1D nanomaterial.

FIG. 5 shows a flowchart of a method for producing a current collector.

FIG. 6 shows a correlation between discharge energy and current distribution non-uniformity for different tab configurations that vary in tab numbers and/or location of the tab(s).

### DETAILED DESCRIPTION

In a first aspect, the invention provides a current collector comprising a porous, freestanding, three-dimensional (3D) structure; and
at least one current collector tab, the at least one tab and the three-dimensional structure being connected, wherein the three-dimensional structure comprises at least one layer that is formed of a one-dimensional (1D) nanomaterial, a two-dimensional (2D) nanomaterial, or mixtures thereof, and wherein the nanomaterial in said layer is aligned towards the at least one tab.

It has been found by the inventors that the claimed current collector is effective to facilitate transportation of charge carriers (e) between the current collector/battery electrode and an external source. In particular, it was found that the 3D structure acts as an artificial electron percolation network that exhibits anisotropic electrical conductivity towards the placement of one or more current collector tab(s). In this implanted artificial electron percolation network with anisotropic areal electrical conductivities where maximum electrical conductivity and lowest electron tortuosity are optimized or enhanced towards the direction and placement of a current collector tab, the differences in e-conductivity between areas farthest and closest to an electrode are between 8% and 120%. In general, conductivity in said porous, freestanding, 3D structure is enhanced towards the direction/location of one or more current collector tab(s) resulting in the reduction of impedance while maintaining maximum uniformity of the current to or from an electrode thereby guaranteeing a reliable, optimized, and safer performance of devices comprising the current collector such as an electrochemical cell, or a primary or secondary rechargeable battery containing alkali and/or alkali earth (e.g., Li, Na, K, Ca, Mg, Al, Zn, etc.) metal/ion, or alkali/alkali earth metal chalcogenide, or alkali/alkali earth-oxygen, or alkali/alkali earth air, including, for example, a high-energy Li-ion, Li-sulfur or Li-oxygen battery.

It was furthermore observed that the enhanced conductivity towards the current collector tab/tabs is due to the presence of artificial electron percolation networks exhibiting significant anisotropy in electrical conductivity governed by the presence of highly advanced low tortuous electron paths, i.e., the aligned nanomaterial provides shortest possible electron-percolation trajectories from the electrode to tab(s) (electronic tortuosity). In contrast, conventional current collectors possess networks of randomly distributed and assembled materials resulting in less uniform current distribution and significantly increased path length of the electronic tortuosity.

It was also found that the nanomaterial is distributed in a non-clustering way and arranged so that directly adjacent nanomaterials (e.g., CNTs) partially overlap along their lengths in a planar direction thereby forming a chain or nanocable. Thus, formed nanocables are separated from each other by tailored spacing and are basically aligned parallel to each other thereby further improving the transportation of charge carriers through the percolation network.

The current collector disclosed herein can be a current collector foil or a current collector substrate. In a generally preferred embodiment of the current collector, the three-dimensional structure is binder-free and/or surfactant-free. In this context, binder-free and/or surfactant-free may be understood that the three-dimensional structure is essentially only formed by the nanomaterial.

Typically, the three-dimensional structure of the current collector disclosed herein can comprise two or more stacked layers, wherein each of the layers, independently of one another, may be formed of a 1D nanomaterial, 2D nanomaterial, or mixtures thereof. For example, a first layer may be formed from a 1D nanomaterial such as CNTs, and a second layer, which is stacked on the first layer, may be formed from a 2D nanomaterial such as graphene or a mixture of 2D nanomaterials such as molybdenum disulfide/graphene nanosheets (MoS₂/GNSs)

According to a generally applicable preference within the context of this disclosure, the stacked layers in the three-dimensional structure are bonded by interlayer van der Waals bonding. The stacking of the layers may, for example, be in vertical direction, which allows combinations of layers with variable vertical composition. In one embodiment, layers made of 1D nanomaterial may be preferred. An exemplary embodiment of a 1D nanomaterial is, for example, a CNT.

According to a further preferred embodiment, the current collector disclosed herein contains a three-dimensional structure that comprises a total of 2 to 5000 stacked layers, 3 to 2000 stacked layers, 4 to 1000 stacked layers, 5 to 500 stacked layers, 6 to 200 stacked layers, 7 to 100 stacked layers, 8 to 50 stacked layers, 9 to 20 stacked layers, or 10 stacked layers. Typically, the three-dimensional structure has a total thickness of from 0.1 to 50 μm, 0.25 to 40 μm, 0.5 to 30 μm, 0.75 to 20 μm or 1 to 10 μm. In one generally preferred embodiment, the layers are stacked on top of each other along the z-axis or x-axis.

According to a generally applicable preference within the context of this disclosure, the stacked layers of the porous, freestanding, 3D structure comprise a combination of (i) and (ii): (i) more than one layer formed from a 1D nanomaterial; and (ii) at least one layer formed from a 2D nanomaterial. It was found that such a combination provides increased active surface area and thereby improves electrical conductivity.

In the context of this disclosure, individual layers composed of 1D nanomaterial may be rotated against each other. For example, the individual layers of the porous, freestanding, 3D structure may be rotated by 90°against each other if they are in a square form, or by 120°against each other if they are in a hexagonal form.

In one of the further preferred embodiments, the porosity of the three-dimensional structure is at least 3% V/V based on the total volume of the 3D structure, for example 10% V/V or more, preferably 50% V/V or more, 80% V/V or more, or 90% V/V or more, more preferably 95% V/V or more. The porosity can be determined by using a Helium pycnometer, in which the sample is enclosed within a closed vessel of a fixed volume at a fixed pressure. Through this technique, porosity is defined as the volume displacement between the empty vessel and the one containing the sample. The morphology of the porous network can, for example, be determined by physical gas adsorption or computed microtomography It was found that due to the alignment, the three-dimensional structure possesses an ordered porosity which also contributes to the optimized anisotropic electrical conductivity towards the current collector tab/tabs.

According to the present invention, the 1D nanomaterial that may form a layer of the three-dimensional structure contained in the current collector can be a nanotube, nanorod, nanofiber, or nanowire. In the context of this disclosure, the carbon nanotube can be single-walled (SWCNT), double-walled (DWCNT) or multi-walled (MWCNT). Typically, the 1D nanomaterial includes or is made of carbonaceous material, non-carbonaceous material, or a mixture thereof. In this context, the size, shape, porosity, and chemical composition of the 1D nanomaterial is not particularly limited. For example, the 1D nanomaterial includes or can be made of carbon, including materials such as graphite and porous carbons; a metal such as Aluminum (Al), Bismuth (Bi), Boron (B), Copper (Cu), Gallium (Ga), Germanium (Ge), Indium (In), Iron (Fe), Gold (Au), Molybdenum (Mo), Platinum (Pt), Ruthenium (Ru), Silicon (Si), Silver (Ag), Selenium (Se), Tin (Sn), Titanium (Ti), Tellurium (Te), Tungsten (W), Vanadium (V), Zinc (Zn), oxides thereof such as CuO, ZnO, TiO₂, MoO₂ and WO₂, and alloys thereof; and a transition metal dichalcogenide such as MoS₂, WS₂, VS₂, VS₄, TiS₂, and TiS₄, or a composite mixture of any of the foregoing The 1D nanomaterial can be doped and/or functionalized with one or more functional groups. Examples of doped 1D nanomaterials may be 1D nanomaterials that are doped with a heteroatom such as fluorine, nitrogen, oxygen, or a combination thereof, including, for example, nitrogen-doped carbon materials. Examples of functional groups include —O, —OH, —COOH, —F, —COO, —NO₃, —NO₂, —R, —Cl, —NH. In the context of this disclosure, the 1D nanomaterial can, for example, be a carbon nanotube or boron-carbon-nitride nanotube. The electrical conductivity of a layer formed of aligned 1D nanomaterial can, for example, be in the range of from 10² S/cm to 10⁶ S/cm along the direction of alignment. Within the scope of one generally preferred embodiment, the 1D nanomaterial is a carbon nanotube.

According to the present invention, the 2D nanomaterial that may form a layer of the three-dimensional structure contained in the current collector can be a nanosheet, nanoflake, or nanoplatelet. Typically, the 2D nanomaterial includes or is made of a carbonaceous material, non-carbonaceous material, or a mixture thereof. In this context, the size, shape, porosity, and chemical composition of the 2D nanomaterial is not particularly limited. For example, the 2D nanomaterial includes or can be made of carbon, including materials such as graphite, porous carbons, graphene and fullerenes; a metal such as Aluminum (Al), Bismuth (Bi), Boron (B), Copper (Cu), Gallium (Ga), Germanium (Ge), Indium (In), Iron (Fe), Gold (Au), Molybdenum (Mo), Platinum (Pt), Ruthenium (Ru), Silicon (Si), Silver (Ag), Selenium (Se), Tin (Sn), Titanium (Ti), Tellurium (Te), Tungsten (W), Vanadium (V), and Zinc (Zn), oxides thereof such as CuO, ZnO, TiO₂, MoO₂ and WO₂, and alloys thereof, a transition metal dichalcogenide such as MoS₂, WS₂, VS₂, VS₄, TiS₂, and TiS₄; a transition metal carbide (MXene) such as Ti₂C, V₂C, Mo₂C, TiAlC₂, and Mo₂TiC₂; a transition metal nitride/carbonitride such as graphitic carbon nitride (g-C₃N₄), hexagonal boron nitride (h-BN), silicene, phosphorene, germanene, boron-carbon-nitride (BCN), aluminum nitride, molybdenum nitride, titanium nitride and alloys thereof, or a composite mixture of any of the foregoing. The 2D nanomaterial can be doped and/or functionalized with one or more functional groups. Examples of doped 2D nanomaterials may be 2D nanomaterials that are doped with a heteroatom such as fluorine, nitrogen, oxygen, or a combination thereof, including, for example, nitrogen-doped carbon materials. Examples of functional groups include —O, —OH, —COOH, —F, —COO, —NO₃, —NO_{2,} —R, —Cl, —NH. Generally preferred examples of 2D nanomaterials, include, for example, a nanosheet of graphene, graphene oxide, reduced graphene oxide, an MXene, g-C₃N₄, h-BN, silicene, phosphorene, germanene, BCN, a transition metal dichalcogenide, or a mixture of the foregoing. The electrical conductivity of a layer formed of aligned 2D nanomaterial can, for example, be in the range of from 10² S/cm to 10⁴ S/cm in plane direction of the layer, Within the scope of one embodiment, the 2D nanomaterial is a nanosheet of graphene, graphene/graphene oxide or MOS₂.

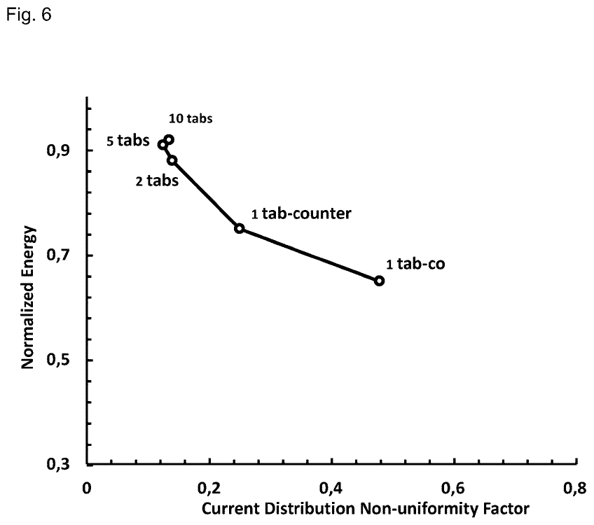

Within the scope of the present disclosure is a current collector that comprises two or more, three or more, four or more, five or more, six or more, or 2 to 10 current collector tabs. As illustrated by FIG. 6, current distribution non-uniformity has a significant effect on energy density. FIG. 6 also demonstrates that the number of tabs and their location are critical elements that affect performance. In general, it was found that an increased number of tabs can improve overall performance, and that tab configuration and overall performance are directly linked. Due to the advanced anisotropic electrical conductivity with tailored electron tortuosity optimized towards the direction of one or more tabs, the tab configuration disclosed herein secures a low current distribution non-uniformity factor and reduces Joule heating and adverse effects associated therewith such as irreversible electrochemical side reactions and reduction of energy density Said another way, the tab configuration provided herein improves current distribution uniformity and overall performance, including, for example, improved energy output, cycle behaviour and safety.

The subject matter of the present disclosure also encompasses an electrode, comprising a current collector as described herein. According to a further aspect, the Invention provides a primary or secondary energy storage device, or an electrochemical cell, comprising the current collector and/or the electrode disclosed herein. The device may, for example, be a battery as mentioned above. In one generally preferred embodiment, the storage device is a lithium-ion or lithium-sulfur battery, in particular a lithium-sulfur battery, including at least one current collector according to the present invention. The devices according to the present invention have the advantages described with respect to the current collector in particular. Specifically, a device such as an energy storage device or electrochemical cell according to the present invention has, in particular, improved electrical and thermal properties due to the presence of the artificial percolation network towards the current collector tab(s), superior cycle behaviour and enhanced safety.

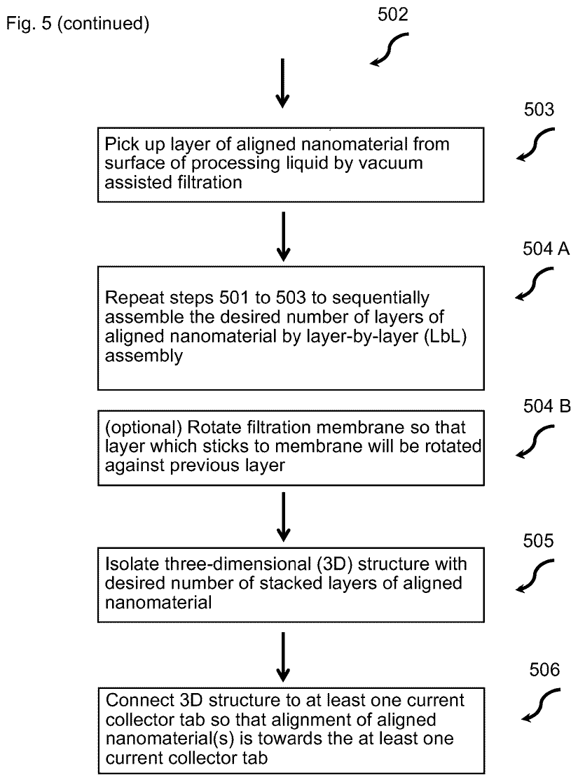

In a further aspect, the invention provides a method for producing a current collector, in particular a current collector as described above. The method for producing a current collector comprises:
(a) providing a porous, freestanding, three-dimensional structure comprising at least one layer that is formed of a one-dimensional (1D) nanomaterial, a two-dimensional (2D) nanomaterial, or mixtures thereof, wherein the nanomaterial is aligned and its longitudinal axis is perpendicular to a substrate surface; and
(b) connecting the three-dimensional structure of step (a) to at least one current collector tab so that the nanomaterial comprised in said three-dimensional structure is aligned towards the at least one tab.
The preparation of 1D nanomaterial, 2D nanomaterial, or mixtures thereof in the form of nanotubes, nanorods, nanofibers, nanowires, nanosheets, nanoplates, or nanoflakes is generally known in the art. As described above, the 1D and 2D nanomaterial include or is made of carbonaceous material, non-carbonaceous material, or a mixture thereof, and such materials are generally known in the art.
An example of a method for producing a current collector according to the principles described herein is illustrated in FIG. 5 as a flow chart. According to the method (500) for producing a current collector, the step of forming a porous, freestanding layer made of an aligned nanomaterial, can include the steps (501 A1 and A2 or 501 B1 and B2) of providing a dispersion/suspension of the nanomaterial, (502) applying an external field to align the dispersed/floated nanomaterial and forming a layer, and (503) recovering the layer.
In one generally preferred embodiment of the method, a dispersion/suspension of nanomaterial is prepared by (501 A1 and A2) adding nanomaterial to a liquid media, followed by chemical and/or mechanical treatment. In an alternative preferred embodiment of the method, a dispersion/suspension of nanomaterial is prepared by (501 B1 and B2) directly laying nanomaterial onto the surface of a liquid media, optionally, followed by mechanical treatment. In this context, dispersion or suspension means that nanomaterial, e.g., CNT and/or graphene, is dispersed or suspended in a liquid media in individual form. In some embodiments, the dispersion/suspension is prepared at room temperature. In some embodiments, the dispersed/suspended nanomaterial floats on the surface of the liquid media. Suitable liquid media include water, ethanol, methanol, acetone, isopropanol (IPA), N,N-dimethylformamide (DMF), N-methyl-2-pyrrolidone (NMP) and dimethylsulfoxide (DMSO), or mixtures thereof. In some embodiments, the liquid media may be water, a mixture of water and ethanol, or acetone. In some embodiments, the liquid media may contain one or more surfactants.
The chemical treatment can, for example, include a functionalization and/or a treatment with a strong acid and/or a surfactant. Suitable strong acids include, for example, nitric acid (HNO₃) and sulfuric acid (H₂SO₄), and mixtures thereof. Examples of a functionalization include the introduction of one or more functional groups selected from —O, —OH, —COOH, —F, —COO, —NO₃, —NO₂, —R, —Cl, —NH₂.
Suitable surfactants include, for example, sodium dodecyl sulfate (SDS), sodium dodecyl benzenesulfonate (SDBS), cetyltrimethylammoniumbromide (CTAB), dodecyl trimethyl ammonium bromide (DTAB), polyoxyethylene octyl phenyl ether (TritonX-100), and mixtures thereof. Surfactants can help to prevent or avoid the formation of aggregates. Suitable mechanical treatments include, for example, sonication, probe-based ultrasound treatment, centrifugation, calendaring, ball milling, and combinations thereof In some embodiments, the nanomaterial is (501 A2) subjected to ultrasound treatment to ensure uniform dispersion/suspension. In some embodiments, the nanomaterial is (501 B2) subjected to an electrostatic dispersion process under applied direct current (DC). In some embodiments, the DC may be high-voltage (HV) DC to ensure uniform dispersion/suspension.

In a generally preferred embodiment of the method, the nanomaterial can be aligned and form a layer by applying an external force to the dispersed/suspended nanomaterial. When the nanomaterial is aligned, its longitudinal axis is perpendicular to a substrate surface. The substrate surface may, for example, be a bottom of a vessel containing the dispersion/suspension or the surface of a filter membrane.

Suitable external forces include, for example, an electrostatic field, electric field, magnetic field, electromagnetic field, or a combination of any of the foregoing. In one embodiment, the dispersion is subjected to an electrostatic field. In another embodiment, the dispersion is subjected to (502) an electric field. In a further embodiment, the dispersion is subjected to a magnetic field. In yet a further embodiment, the dispersion is subjected to an electromagnetic field. In a generally preferred embodiment, an alternating current (AC) electric field can be applied to the liquid dispersion/suspension to align the nanomaterial and form a layer. For example, the AC may be HVAC such as HVAC operating at a power of from 1 kV to 300 kV and a frequency ranging of from 3 kHz to 1.2 MHz. Due to the application of the external force, the nanomaterial aligns along the direction of the applied external force and thereby forms a layer.

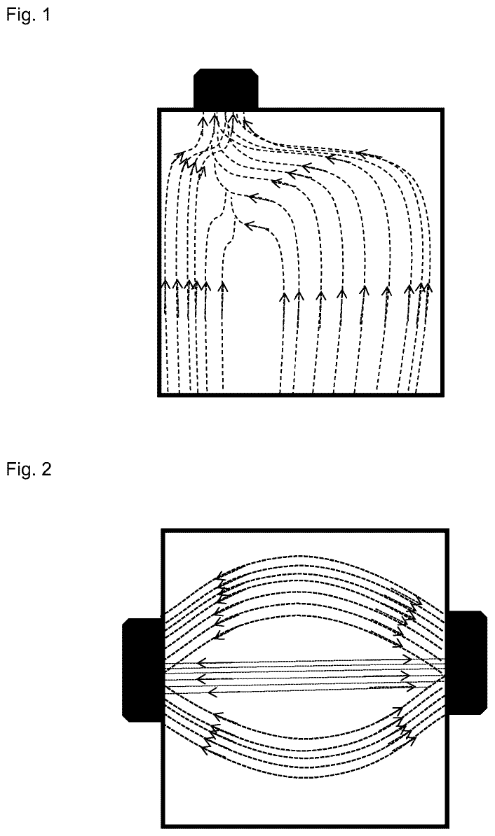

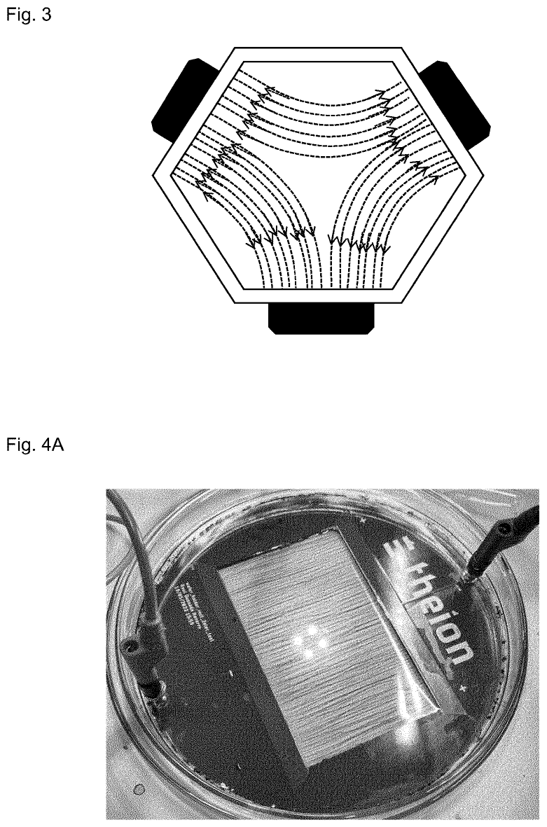

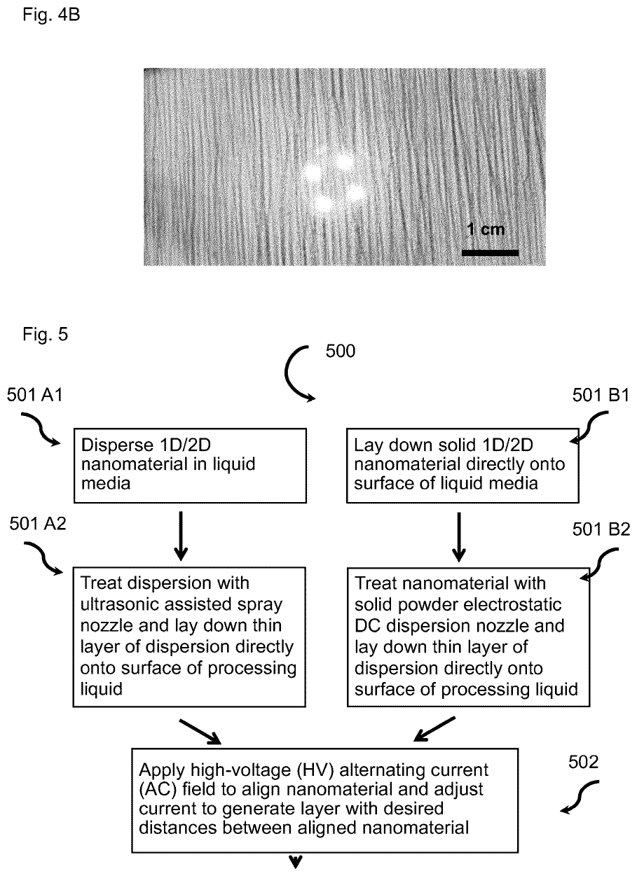

In addition, the external force may in situ generate internal forces in the nanomaterial such as electric field-induced magnetic fields (right-hand rule) generated by charge flowing through the aligned/chained lines and the external magnetic field generated preferably by Helmholtz coils. Such internal forces can be used to control and/or tailor the inter-distances between aligned nanomaterial as well as the porosity within the layer structure. In some embodiments, the aligned 1D nanomaterial may form nanocables as illustrated in FIGS. 1 to 4. For example, the inter-distances between lines formed by aligned nanomaterials, e.g., CNTs, can be adjusted by the amount of electric current flowing through them due to the in situ generated magnetic field, which has a repulsive effect on neighboring lines formed by aligned nanomaterials (nanocables). The stronger the electric current, the stronger the magnetic field, and as a result the inter-distances between the individual nanocables increase; or vice-versa, the weaker the electric current; the lower the repulsive effect resulting in more tightly packed nanocables. Naturally, the same applies to the porosity, the tighter the nanocables are packed, the lower the porosity within the layer formed.

In this context, it is generally preferred to apply an electric field (AC and/or DC) for the alignment of the nanomaterial in a water-based liquid dispersion/suspension.

In a generally preferred embodiment of the method, the layer of aligned nanomaterial formed from the liquid dispersion of the nanomaterial can be (503) recovered by vacuum filtration using a filter membrane. It was found that vacuum-assisted filtering through a suitable membrane allows to obtain a layer of aligned nanomaterial without disturbing or altering the alignment, i.e. direction of formed nanocables and distances between the nanocables.

The filter membrane may have nanopores, nanochannels, micropores, microchannels, macropores, macrochannels, or combinations thereof. In addition, the filter membrane may be hydrophilic or have a hydrophilic coating. In some embodiments, the filter membrane may be porous with variable pore sizes ranging of from 20 nm to 50 micrometers.

In a generally preferred embodiment, vacuum filtration may be carried out at low speed, in particular the filtration speed may be as slow as possible. It was found that a slow filtration speed is particularly helpful in preserving the alignment and causes the layer of aligned nanomaterial to float on the surface of the liquid media, so that the layer of aligned nanomaterial can be easily picked up/lifted from the liquid media without disturbing the alignment. The filtration speed may, for example, be in the range of from 10 ml/min to 100 ml/min.

After the filtration, the layer of aligned nanomaterial may be isolated from the filter membrane, cured, washed, and/or dried. In a generally preferred embodiment, residual solvent and/or surfactant can be removed by washing with deionized water, isopropyl alcohol, methanol, or mixtures thereof; by calcination; or a combination of any of the foregoing. Typically, presence of solvent or surfactant negatively influences physical and/or electrical properties of the layer of aligned nanomaterial.

The thickness of the layer of aligned nanomaterial can be controlled by the filtration volume and/or concentration of nanomaterial contained in the liquid dispersion. The thickness of a layer of aligned nanomaterial may, for example, be in the range of from about 50 to 1000, 100 to 750, 200 to 600, 250 to 500, or 300 to 350 nm.

In some preferred embodiments, the layer of aligned nanomaterial may have at least one electroconductive and/or electrochemically active planar surface. The surface area of the planar surface can be in the range of from a few mm² to several m², for example, of from 10 cm² to 100 cm².

In a generally preferred embodiment of the method, the porous, freestanding, three-dimensional structure can be provided by (504 A) a layer-by-layer (LbL) assembly method, where individual layers of aligned nanomaterial obtained from the above-described dispersion and vacuum filtration steps are stacked on top of each other. In some embodiments, the layers are vertically stacked on top of each other. In other words, the step of providing the porous, freestanding, three-dimensional structure is performed by preparing one or more individual layers of aligned nanomaterial as described above and assembling them by stacking the required number and types (i.e. nanomaterial constituents used to form layer) of individual layers on top of each other along the z-axis. In the context of this disclosure, individual layers composed of 1D nanomaterial may be rotated against each other when performing the (504 B) layer-by-layer (LbL) assembly method. For example, the individual layers of the porous, freestanding, 3D structure may be rotated by 90° against each other if the layers are in a square form, or by 120° against each other if the layers are in a hexagonal form.

According to a preferred embodiment, a total of 2 to 5000, 3 to 2000, 4 to 1000, 5 to 500, 6 to 200, 7 to 100, 8 to 50, 9 to 20, or 10 or more layers of aligned nanomaterial are stacked together by performing the layer-by-layer (LbL) assembly method. Typically, a three-dimensional structure obtained by LbL assembly of individual layers of aligned nanomaterial can have a total thickness of from 0.1 to 50 μm, 0.25 to 40 μm, 0.5 to 30 μm, 0.75 to 20 μm or 1 to 10 μm.

According to a generally applicable preference within the context of this disclosure, the stacked layers of three-dimensional structure comprise a combination of (i) and (ii): (i) more than one layer formed from a 1D nanomaterial; and (ii) at least one layer formed from a 2D nanomaterial. In some embodiments, the porous, freestanding, 3D structure may solely be formed by assembling layers of aligned nanomaterial that are made from a 1D nanomaterial. The method further comprises the step of connecting or interlacing at least one current collector tab to the porous, freestanding, 3D structure comprising at least one layer of aligned nanomaterial, so that the nanomaterial comprised in said 3D structure is aligned towards the at least one tab. In a generally preferred embodiment of the method, a current collector tab can be (506) connected to or interlaced with the porous, freestanding, 3D structure obtained by the LbL process described above to thereby form a current collector foil or current collector substrate as disclosed herein. In this context, it is essential that the connection results in alignment of aligned nanomaterial(s) towards a current collector tab. The alignment of the nanomaterial and the current collector tab(s) described herein is crucial to obtain anisotropic electrical conductivity and highly advanced low tortuous electron paths from electrode to tab(s) via the artificial electron percolation network formed by the porous, freestanding, 3D structure. In some embodiments, a current collector tab may be connected to the porous, freestanding, 3D structure by ultrasonic welding, resistance welding, laser welding, stamping, or crimping, so that the nanomaterial comprised in the 3D structure is aligned towards the tab.

It should be noted that the description and drawings have only illustrative character and are not intended to limit the scope of the invention, which is defined by the attached claims.

1. A current collector comprising:
a porous, freestanding, three-dimensional structure; and
at least one current collector tab, the at least one tab and the three-dimensional structure being connected,
wherein the three-dimensional structure comprises at least one layer that is formed of a one-dimensional (1D) nanomaterial, a two-dimensional (2D) nanomaterial, or mixtures thereof, and
wherein the nanomaterial in said layer is aligned towards the at least one tab.

2. The current collector of claim 1, wherein the three-dimensional structure is at least one of binder-free and surfactant-free.

3. The current collector of claim 1, wherein the three-dimensional structure comprises two or more stacked layers, each of the layers, independently of one another, being formed of a 1D nanomaterial, 2D nanomaterial, or mixtures thereof.

4. The current collector of claim 3, wherein the stacked layers are bonded by interlayer van der Waals bonding.

5. The current collector of claim 3, wherein the three-dimensional structure comprises a total of 2 to 5000 stacked layers, 3 to 2000 stacked layers, 4 to 1000 stacked layers, 5 to 500 stacked layers, 6 to 200 stacked layers, 7 to 100 stacked layers, 8 to 50 stacked layers, 9 to 20 stacked layers, or 10 stacked layers.

6. The current collector of claim 1, wherein the three-dimensional structure has a total thickness of from 0.1 to 50 pm, 0.25 to 40 pm, 0.5 to 30 pm, 0.75 to 20 pm or 1 to 10 pm.

7. The current collector of claim 1, wherein the porosity of the three-dimensional structure is at least 3% V/V based on the total volume of the three-dimensional structure, preferably 50% V/V or more, 80% V/V or more, or 90% V/V or more, more preferably 95% V/V or more.

8. The current collector of claim 1, wherein the 1D nanomaterial is a nanotube, nanorod, nanofiber, or nanowire.

9. The current collector of claim 1, wherein the 2D nanomaterial is a nanosheet, nanoflake, or nanoplatelet.

10. The current collector of claim 1, wherein the 1D or 2D nanomaterial consists of a carbonaceous material, non-carbonaceous material, or a mixture thereof.

11. The current collector of claim 1, wherein the current collector comprises two or more, three or more, four or more, five or more, six or more, or 2 to 10 current collector tabs.

12. An electrode comprising the current collector according to claim 1.

13. A primary or secondary energy storage device comprising the current collector according to claim 1.

14. The storage device of claim 13, wherein the storage device is a lithium-ion or lithiumsulfur battery.

15. A method for producing a current collector, the method comprising:
(a) providing a porous, freestanding, three-dimensional structure comprising at least one layer that is formed of a one-dimensional (1 D) nanomaterial, a two-dimensional (2D) nanomaterial, or mixtures thereof, wherein the nanomaterial is aligned and its-a longitudinal axis thereof is perpendicular to a substrate surface; and
(b) connecting the three-dimensional structure of step (a) to at least one current collector tab so that the nanomaterial comprised in said three-dimensional structure is aligned towards at least one tab.
